(19) United States
(12) Patent Application Publication
(10) Pub. No.: US 2025/0310500 A1
(43) Pub. Date: Oct. 2, 2025

(54) IMAGE PROCESSING APPARATUS, IMAGE PROCESSING METHOD, AND RECORDING MEDIUM

(71) Applicant: CANON KABUSHIKI KAISHA, Tokyo (JP)

(72) Inventor: NOZOMU KASUYA, Kanagawa (JP)

(21) Appl. No.: 19/085,940

(22) Filed: Mar. 20, 2025

(30) Foreign Application Priority Data
Mar. 28, 2024 (JP) 2024-053579

(51) Int. Cl. H04N 13/111; G06T 7/80; H04N 13/296

(52) U.S. Cl. CPC H04N 13/111; G06T 7/80; H04N 13/296; G06T 2207/10021

(57) ABSTRACT

An imaging processing apparatus includes one or more memories storing instructions, and one or more processors executing the instructions to acquire a first image captured by an imaging apparatus, generate a second image by performing processing of increasing the number of pixels with respect to the first image, and set information indicating a position and an orientation of a virtual camera corresponding to the second image.

### BACKGROUND

### Field

The present disclosure relates to an image processing apparatus, an image processing method, and a storage medium, in particular, a technique for generating free-viewpoint video.

### Description of the Related Art

A technique has attracted attention for generating a virtual viewpoint image using a plurality of images of the same subject captured simultaneously by a plurality of imaging apparatuses installed at different positions. The technique for generating a virtual viewpoint image from a plurality of captured images enables the inclusion of a viewpoint corresponding to a position that has been difficult for an imaging apparatus to access, allowing video creators to produce dramatic viewpoint contents.

To generate a virtual viewpoint image using the technique, a large number of imaging apparatuses are used. However, the number of imaging apparatuses and image quality of a virtual viewpoint image have a trade-off relationship. Thus, there is a demand for a method of enhancing image quality without increasing the number of imaging apparatuses. As a measure, WO 2018/147329 discusses a method for generating an image by increasing the number of pixels using super-resolution technique. In WO 2018/147329, a plurality of captured images, a three-dimensional model, and camera parameters are input to a trained model, which outputs a high-definition virtual viewpoint image with an increased number of pixels using super-resolution technique.

### SUMMARY

According to an aspect of the present disclosure, an imaging processing apparatus includes one or more memories storing instructions, and one or more processors executing the instructions to acquire a first image captured by an imaging apparatus, generate a second image by performing processing of increasing the number of pixels with respect to the first image, and set information indicating a position and an orientation of a virtual camera corresponding to the second image.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a virtual viewpoint image generation system according to an exemplary embodiment.

FIG. 2 is a diagram illustrating an example of a hardware configuration of an image processing apparatus according to the present exemplary embodiment.

FIG. 3 is a diagram illustrating a configuration of the image processing apparatus according to the present exemplary embodiment.

FIG. 4 is a flowchart illustrating image processing performed by the image processing apparatus according to the present exemplary embodiment.

FIG. 5 is a flowchart illustrating a process of generating geometric information about a virtual camera by the image processing apparatus according to the present exemplary embodiment.

FIG. 6 is a diagram illustrating an overview of the process of generating geometric information about the virtual camera by the image processing apparatus according to the present exemplary embodiment.

FIG. 7 is a flowchart illustrating a process of generating a virtual viewpoint image by a rendering apparatus according to the present exemplary embodiment.

### DESCRIPTION OF THE EMBODIMENTS

In WO 2018/147329, processing of enhancing image quality is performed every time processing of generating a virtual viewpoint image is performed. Thus, as the number of virtual viewpoints increases, the frequency of image quality enhancement processing also increases. This increases the processing load on an image generating apparatus that generates virtual viewpoint images.

The present disclosure enables reduction in processing load during high-definition virtual viewpoint image generation.

According to an aspect of the present exemplary embodiment, an image processing apparatus includes an acquisition unit configured to acquire a first image captured by an imaging apparatus. The image processing apparatus includes a generation unit configured to generate a second image by performing processing of increasing the number of pixels with respect to the first image. Further, the image processing apparatus includes a setting unit configured to set information indicating a position and an orientation of a virtual camera corresponding to the second image.

The processing of increasing the number of pixels herein refers to, for example, processing of increasing the number of pixels using super-resolution technique. The super-resolution technique refers to a technique for increasing the resolution of an image by increasing the number of pixels or increasing the size of the image. The technique may be used as long as the number of pixels is increased, and both the resolution and the image size can be increased. The super-resolution technique comes in two types: a learning-based method using machine learning and a reconstruction-based method using interpolation with a plurality of images or surrounding pixels. Further, the processing of increasing the number of pixels can be performed on a partial region of the first image. For example, an image corresponding to the partial region may be cropped from the first image, and the processing of increasing the number of pixels may be performed with respect to the cropped image. In this case, the processing load to increase the number of pixels is reduced.

Further, the processing performed by the generation unit is not limited to the processing of increasing the number of pixels, and any processing can be performed as long as the processing enhances image quality. For example, the processing can be noise reduction processing.

The first image is captured by an imaging apparatus. For example, the first image is an image of a player captured by an imaging apparatus installed in a stadium, or an image of a performer captured by an imaging apparatus installed in a studio. The second image is an image with a greater number of pixels than that of the first image. The imaging apparatus refers to a camera installed in a stadium, a studio, or other places. The imaging apparatus can be a camera mounted on a drone or a camera operated by a camera operator.

This aspect can use the image subjected to the processing of increasing the number of pixels and information indicating the position and the orientation of the virtual camera corresponding to the image to generate a virtual viewpoint image. Setting the position and the orientation of the virtual camera allows an image captured by the imaging apparatus close to the position of the virtual camera to be preferentially used in a coloring process that more accurately reproduces hues as viewed from the virtual camera. In particular, with an increased number of virtual viewpoints, the second image and information indicating the position and the orientation of the virtual camera corresponding to the second image can be used in a plurality of processes of generating virtual viewpoint images corresponding to the virtual viewpoints. This reduces the processing load in generating a high-definition virtual viewpoint image.

The image can be used in the coloring process, as well as in a process of generating three-dimensional shape information about a subject. For example, a silhouette image can be generated by the pixels corresponding to the subject and the pixels not corresponding to the subject being distinguished from each other in the image subjected to the processing of increasing the number of pixels, and three-dimensional shape information about the subject can be generated using the silhouette images and the visual hull reconstruction method. In this case, three-dimensional shape information about the subject with higher shape accuracy can be generated.

The above-described method is not the only method for generating three-dimensional shape information about the subject. For example, photogrammetry can be used to generate three-dimensional shape information.

The image can be used in a process of generating a virtual viewpoint image, which is different from the coloring process that more accurately reproduces hues as viewed from the virtual camera. For example, the image can be used as training data in a method for calculating colors, red, green, and blue (RGB) and density (σ) as viewed from coordinates (x, y, z) in a space and a line-of-sight angle (θ, φ) using a trained model.

The setting unit of the image processing apparatus sets information indicating the position and the orientation of the virtual camera corresponding to a second region including at least a portion of the subject included in the second image.

With this aspect, the setting unit can set information indicating the position and the orientation of the virtual camera for a region including the subject included in the second image.

When the subject is, for example, a person, the phrase “at least a portion of the subject” refers to the head or a hand of the person. When the subject included in the second image is divided into a plurality of portions, the phrase “at least a portion of the subject” refers to one or more of the divided portions. The second region is a region including at least a portion of the subject and may include an excess region that does not include the subject. Further, a region enclosing the subject may be a rectangle circumscribing the subject or a region cropped along the contour of the subject.

The second region is a region enclosing the subject included in the second image. In other words, the second region includes a single subject in its entirety. When a plurality of subjects is present in the second image, the second region may be a region enclosing all of the plurality of subjects.

With this aspect, the setting unit can set information indicating the position and the orientation of the virtual camera corresponding to the region including the subject.

The acquisition unit of the image processing apparatus may acquire a size of the first image, and the second region may be the same size as the first image. The size of the first image refers to the image size of the first image.

With this aspect, an angle of view of the imaging apparatus corresponding to the first image and an angle of view of the virtual camera corresponding to the second region can be set to the same angle of view. Since an image and a focal length have a predefined relationship, the focal length of the imaging apparatus corresponding to the first image and the focal length of the virtual camera corresponding to the second region can be set to the same focal length.

Further, by setting a size of the first image and a size of the set region corresponding to the virtual camera to the same, the size of the image generated by cropping the region corresponding to the virtual camera from the second image matches the size of the first image. This makes it possible to use processing that can be performed under a condition that a plurality of images is the same size. For example, processing of coloring a three-dimensional model of the subject based on a plurality of images of the same image size can be used.

The second region may be a region including at least a portion of a first region in the second image generated by enlarging a region enclosing the subject included in the first image through the above-described processing to increase the number of pixels. For example, the first region may be divided into a plurality of regions, and the second region may include one or more of the divided regions.

The image processing apparatus can further include a detection unit configured to detect a region enclosing the subject included in the first image. For example, an image that shows the subject alone is generated by comparing an image of the subject captured by the imaging apparatus and a background image captured without the subject. Thereafter, a region enclosing the subject is detected from the image that shows the subject alone. The image that shows the subject alone may be a silhouette image formed by pixels that indicate whether the pixels correspond to the subject. Further, a region enclosing the subject is detected using machine learning. For example, a model is generated by training the model with an image of the subject captured by the imaging apparatus and a ground truth image that defines a region enclosing the subject in the captured image, and the region enclosing the subject is detected using the trained model.

The image processing apparatus can further include an output unit configured to output the second image and information indicating a position and an orientation of the virtual camera to an external apparatus. The external apparatus is, for example, a database that stores captured images used to generate a virtual viewpoint image and three-dimensional shape information about the subject, or an image processing apparatus configured to generate a virtual viewpoint image using a plurality of images.

The acquisition unit can acquire information indicating the position and the orientation of the imaging apparatus, and the information indicating the position and orientation of the virtual camera can be set based on the information indicating the position and orientation of the imaging apparatus and information about the processing of increasing the number of pixels. This aspect can easily set a position and an orientation of the virtual camera.

The acquisition unit can acquire the first image from a plurality of images of the subject captured from a plurality of directions. For example, a specific captured image can be acquired from a plurality of captured images used to generate a virtual viewpoint image based on a user operation. This aspect can adjust the total number of images on which processing is performed of increasing the number of pixels based on the image quality of the virtual viewpoint image to be generated, and reduce the load on the processing to increase the number of pixels. For example, if the processing of increasing the number of pixels is intended to be performed on the image alone used for coloring the subject included in the virtual viewpoint image, the processing of increasing the number of pixels can be performed on the image(s) alone captured by the imaging apparatus close to the position of the virtual camera.

Further, the acquisition unit can acquire all images from a plurality of images of the subject captured in a plurality of directions.

The information indicating the position and the orientation of the imaging apparatus includes information indicating the focal length of the imaging apparatus. Further, the information indicating the position and the orientation of the virtual camera includes information indicating the focal length of the virtual camera. The focal length and the angle of view have a predefined relationship. For example, as the focal length decreases, the angle of view widens, whereas as the focal length increases, the angle of view narrows. With this relationship, the image size of a post-processing image can be calculated from the image size of a pre-processing captured image by changing the image size (the angle of view) alone without changing the resolution when the processing of increasing the number of pixels is performed.

Specifically, with this aspect, a focal length of the image after the processing of increasing the number of pixels can be calculated from a focal length of the image prior to the processing of increasing the number of pixels. The focal lengths may be represented in millimeters or in pixel units. In an exemplary embodiment described below, the focal lengths are represented in pixel units. The information indicating the position and the orientation of the imaging apparatus may include information indicating coordinates of the image center of the captured image corresponding to the imaging apparatus. Further, information indicating a position and an orientation of the imaging apparatus can be considered as extrinsic parameters of the imaging apparatus, and information indicating a focal length and an image center of the imaging apparatus can be considered as intrinsic parameters of the imaging apparatus. Geometric information about the imaging apparatus can include the extrinsic and intrinsic parameters of the imaging apparatus. The geometric information about the imaging apparatus is not limited to that described above and may include information indicating the position and the orientation of the imaging apparatus alone.

According to another aspect of the present exemplary embodiment, an imaging processing system includes an acquisition unit configured to acquire a first image captured by an imaging apparatus. The imaging processing system includes a generation unit configured to generate a second image by performing processing of increasing the number of pixels with respect to the first image. The imaging processing system includes a setting unit configured to set first viewpoint information indicating a position and an orientation of a virtual camera corresponding to the second image. The imaging processing system includes an acquisition unit configured to acquire second viewpoint information indicating a position and an orientation of another virtual camera different from the virtual camera. Further, the imaging processing system includes a generation unit configured to generate a virtual viewpoint image based on the second image, the first viewpoint information, and the second viewpoint information.

According to yet another aspect of the present exemplary embodiment, an image processing method includes acquiring a first image captured by an imaging apparatus. The image processing method includes generating a second image by performing processing of increasing the number of pixels with respect to the first image. Further, the image processing method includes setting first viewpoint information indicating a position and an orientation of a virtual camera corresponding to the second image.

According to yet another aspect of the present exemplary embodiment, a recording medium for performing the above-described control method can be used.

The present exemplary embodiment will now be described in detail below with reference to the attached drawings. The following exemplary embodiment is not intended to limit the claimed disclosure. While the exemplary embodiment describes a plurality of features, not all of the plurality of features are used for the disclosure. The plurality of features can be used in any combination. Further, in the attached drawings, the same or similar components are assigned the same reference numeral, and the redundant descriptions are omitted.

In the present exemplary embodiment, an image that corresponds to a region alone including an imaging target, i.e., a subject (a foreground) with an increased number of pixels as a result of processing using super-resolution technique is generated in a database for generating a virtual viewpoint image. The generated image is registered in the database. The super-resolution technique generates an image with a higher resolution than an input image by predicting and interpolating the input image based on surrounding pixels. The method uses images from a plurality of viewpoints as input, a plurality of frames as input, or a single image as input. In the present exemplary embodiment, the method is described using processing with super-resolution technique in which a single image is used as input. The processing using super-resolution technique in the present disclosure is described as processing of increasing the image size without improving the resolution. However, this is not a limitation, and the resolution can be improved.

A virtual viewpoint image generation system 1 is a system configured to generate a virtual viewpoint image representing a scene from the virtual camera based on a plurality of images captured by a plurality of imaging apparatuses 10 and position and orientation information about the virtual camera acquired by an input apparatus 50. The virtual viewpoint image in the present exemplary embodiment, also referred to as a free-viewpoint video, is not limited to an image corresponding to a viewpoint freely (without restrictions) designated by the user, and can also include, for example, an image corresponding to a viewpoint selected from a plurality of candidates by the user. While the present exemplary embodiment mainly describes a case where the virtual viewpoint is designated from a user operation, the virtual viewpoint can be designated automatically based on an image analysis result. Further, while the present exemplary embodiment mainly describes a case where the virtual viewpoint image is a moving image, the virtual viewpoint image can be a still image.

Viewpoint information used to generate a virtual viewpoint image is information indicating a position and an orientation (a line-of-sight direction from the virtual camera) of the virtual camera. Specifically, viewpoint information is a parameter set that includes parameters indicating a three-dimensional position of the virtual camera and parameters indicating an orientation of the virtual camera in pan, tilt, and roll directions. The details of viewpoint information are not limited to those described above.

The parameter set as viewpoint information may include parameters representing a field of view (an angle of view) of the virtual camera. Viewpoint information may include a plurality of parameter sets. For example, viewpoint information may be information that includes a plurality of parameter sets respectively corresponding to a plurality of frames constituting a moving image of a virtual viewpoint image and indicates a position and an orientation of the virtual camera at a plurality of consecutive time points.

The virtual viewpoint image generation system 1 includes the plurality of imaging apparatuses 10 configured to capture an imaging region 2 from a plurality of directions. The imaging region 2 is, for example, a stadium where competitions, such as soccer or karate, are held, or a stage where concerts or plays are held. The plurality of imaging apparatuses 10 is installed at different positions around the imaging region 2 and captures images synchronously. The plurality of imaging apparatuses 10 may not be installed around the perimeter of the imaging region 2, and may be installed at some portions alone of the perimeter of the imaging region 2 depending on restrictions of installation sites. Further, the number of imaging apparatuses is not limited to the illustrated example, and if the imaging region 2 is, for example, a soccer stadium, approximately thirty imaging apparatuses 10 may be installed around the stadium. The imaging apparatuses 10 having different functions, such as telephoto cameras and wide-angle cameras, can be installed. The plurality of imaging apparatuses 10 according to the present exemplary embodiment is a plurality of cameras each having an independent housing and configured to capture images from a single viewpoint. However, this is not a limitation, and two or more imaging apparatuses 10 can be configured in a housing. For example, a single camera including a plurality of lens units and a plurality of sensors and configured to capture images from a plurality of viewpoints can be installed as the plurality of imaging apparatuses 10.

A virtual viewpoint image is generated by, for example, the following method. First, the plurality of imaging apparatuses 10 performs imaging from different directions to capture a plurality of images (a plurality of viewpoint images). A foreground image is then acquired by extracting a foreground region corresponding to a predetermined object, such as a person or ball, from the plurality of viewpoint images, and a background image is acquired by extracting a background region excluding the foreground region from the plurality of viewpoint images. Further, a foreground model representing a three-dimensional shape of the predetermined object and texture data for coloring the foreground model are generated based on the foreground image, and texture data for coloring a background model representing a three-dimensional shape of the background, such as a stadium, is generated based on the background image. A virtual viewpoint image is generated by mapping the texture data to the foreground model and the background model and rendering them based on the virtual viewpoint indicated by the viewpoint information. However, this is not the only method for generating a virtual viewpoint image, and various other methods can be used, such as a method for generating a virtual viewpoint image through perspective transformation of captured images without using three-dimensional models.

The virtual camera refers to a virtual camera different from the actual imaging apparatuses 10 installed around the imaging region 2 and is a concept introduced to simplify the explanation of a virtual viewpoint related to generating a virtual viewpoint image. Specifically, a virtual viewpoint image can be regarded as an image captured from a virtual viewpoint set in a virtual space associated with the imaging region 2. Further, the position and the orientation of the virtual viewpoint in this image capturing can be represented as the position and the orientation of the virtual camera. In other words, a virtual viewpoint image can be regarded as an image generated to simulate an image captured by a camera assumed to be at a virtual viewpoint position set in a space. In the present exemplary embodiment, the detail of temporal changes in the virtual viewpoint will be referred to as a virtual camera path. However, it is not essential to use the concept of the virtual camera to implement the configuration according to the present exemplary embodiment. Specifically, it is sufficient to at least set information indicating a specific position in a space and information indicating an orientation, and generate a virtual viewpoint image based on the set information.

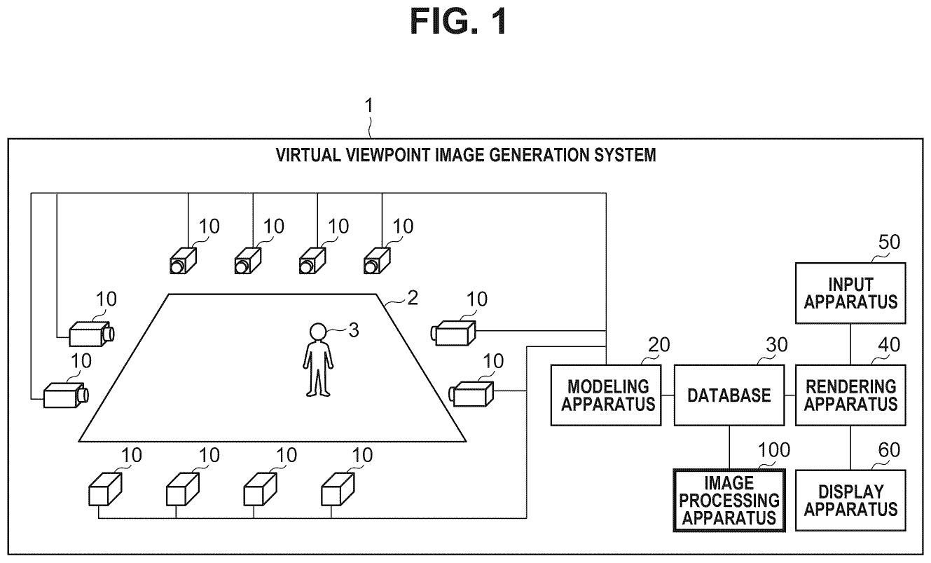

FIG. 1 is a diagram illustrating a configuration of the virtual viewpoint image generation system 1 configured to generate a virtual viewpoint image. In the virtual viewpoint image generation system 1, the plurality of imaging apparatuses 10 captures images of a subject 3 in the imaging region 2, i.e., the foreground. Then, a virtual viewpoint image is generated based on the plurality of images captured by the plurality of imaging apparatuses 10. For example, the plurality of imaging apparatuses 10 is arranged to surround the subject 3, as illustrated in FIG. 1, and captures images of the imaging region 2 from different imaging positions. A modeling apparatus 20 generates three-dimensional shape information representing a three-dimensional shape of the subject 3 using the images captured by the imaging apparatuses 10. The pieces of generated three-dimensional shape information are stored in a database 30 in association with the captured images. The database 30 stores the three-dimensional shape information generated by the modeling apparatus 20, as well as information used for rendering, such as geometric information about the imaging apparatuses 10 and the captured images. A rendering apparatus 40 generates a virtual viewpoint image corresponding to a virtual camera input from the input apparatus 50 using data stored in the database 30. The rendering apparatus 40 employs a viewpoint-dependent rendering method using mainly the image captured by the nearest imaging apparatus 10 based on the position of the input virtual camera. The input apparatus 50 inputs information indicating a position and an orientation of the virtual camera, and outputs information indicating a position and an orientation of the virtual camera used for generating a virtual viewpoint image to the rendering apparatus 40. A display apparatus 60 displays the virtual viewpoint image generated by the rendering apparatus 40.

The viewpoint-dependent rendering method refers to a method in which color information corresponding to three-dimensional shape information about a subject is generated using information indicating a position and an orientation of a virtual camera to generate a virtual viewpoint image.

For example, color information is determined based on an image captured by the imaging apparatus 10 in a line-of-sight direction (an orientation) close to a line-of-sight direction (an orientation) from the virtual camera. Color information about a subject region invisible from the imaging apparatus 10 in the closest line-of-sight direction to the line-of-sight direction from the virtual camera is determined using color information from the image captured by the imaging apparatus 10 in the second closest line-of-sight direction to the imaging apparatus 10 in the closest line-of-sight direction. At this time, color can be determined from an image captured by a single imaging apparatus 10, or can be generated by combining a plurality of captured images using weights. Specifically, since an imaging apparatus 10 for generating color information about the subject is selected from the plurality of imaging apparatuses 10 based on the position and the orientation of the virtual camera, color information about the subject changes as the virtual viewpoint moves. For this reason, this method is referred to as a viewpoint-dependent rendering.

An image processing apparatus 100 acquires data stored in the database 30, performs processing on the captured image using super-resolution technique, generates geometric information about the virtual camera corresponding to the generated image, and writes the geometric information back to the database 30. Details of the geometric information will be described below.

The plurality of imaging apparatuses 10 can perform imaging synchronously and continuously. In this case, the virtual viewpoint image generation system 1 can generate three-dimensional shape information about the subject over time and, furthermore, generate virtual viewpoint images representing temporal changes, i.e., a virtual viewpoint video. In this configuration, the input apparatus 50 can designate a virtual camera with a position that changes over time. A trajectory of positions of the virtual camera, which changes (moves) over time as described above, is also referred to as a virtual camera path or a camera work.

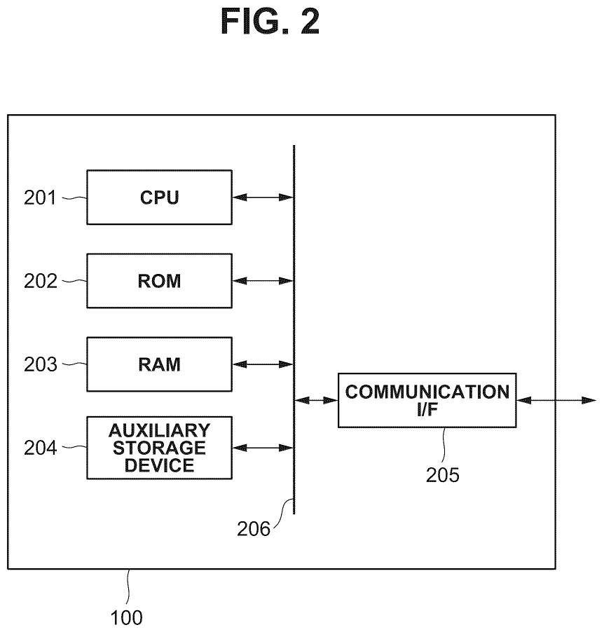

FIG. 2 is a block diagram illustrating an example of a hardware configuration of a computer applicable to the image processing apparatus 100 according to the present exemplary embodiment. The image processing apparatus 100 includes a central processing unit (CPU) 201, a read-only memory (ROM) 202, a random access memory (RAM) 203, an auxiliary storage device 204, a communication interface (communication I/F) 205, and a bus 206. The modeling apparatus 20 can also be implemented using similar hardware. Further, the rendering apparatus 40 can include, for example, a plurality of image processing apparatuses connected via a network.

The CPU 201 carries out the functions of the processing units of the image processing apparatus 100 illustrated in FIG. 1 by generally controlling the image processing apparatus 100 using computer programs or data stored in the ROM 202 or the RAM 203. The image processing apparatus 100 can include a piece or a plurality of dedicated hardware different from the CPU 201. In this case, the dedicated hardware can perform at least some of the processes performed by the CPU 201. Examples of dedicated hardware include an Application-Specific Integrated Circuit (ASIC), a field programmable gate array (FPGA), and a digital signal processor (DSP).

The ROM 202 is a memory configured to store programs that do not involve modifications. The RAM 203 is a memory configured to temporarily store programs or data supplied from the auxiliary storage device 204 and data supplied from an external source via the communication I/F 205. The auxiliary storage device 204 includes, for example, a storage, such as a hard disk drive, and stores various types of data, such as image data or audio data. The communication I/F 205 is used to communicate with external apparatuses outside of the image processing apparatus 100. For example, when the image processing apparatus 100 is connected to an external apparatus through wire, a cable for communication is connected to the communication I/F 205. When the image processing apparatus 100 communicates with an external apparatus wirelessly, the communication I/F 205 includes an antenna. The bus 206 connects units of the image processing apparatus 100 to transmit information.

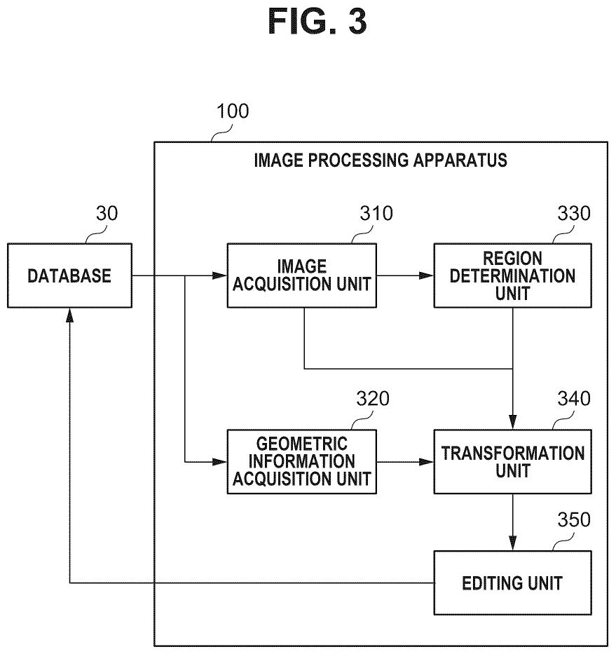

FIG. 3 is a diagram illustrating a configuration of the image processing apparatus 100 according to the present exemplary embodiment. The image processing apparatus 100 includes an image acquisition unit 310, a geometric information acquisition unit 320, a region determination unit 330, a transformation unit 340, and an editing unit 350.

The image acquisition unit 310 acquires images captured by the imaging apparatuses 10 from the database 30 of the virtual viewpoint image generation system 1. The acquired images are output to the region determination unit 330 and the transformation unit 340. A single image is acquired from the plurality of images captured by the plurality of imaging apparatuses 10. Which image to acquire can be determined by the user. The acquired image is an example of the first image.

The geometric information acquisition unit 320 acquires, from the database 30, parameters representing geometric information, such as a focal length and an image center of the imaging apparatus 10 corresponding to the acquired image, and outputs the acquired parameters to the transformation unit 340. The geometric information includes intrinsic parameters, such as a focal length f and an image center (cx, Cy), and extrinsic parameters representing a position t and an orientation R of the imaging apparatus 10. By using the intrinsic and extrinsic parameters, coordinates (u, v) on an image captured by the imaging apparatus 10, where three-dimensional coordinates X in the imaging region 2 appear, can be calculated using the following formula:

$$( \begin{matrix}u \\ v \\ 1\end{matrix} ) = ( \begin{matrix}f & 0 & {c}_{x} \\ 0 & f & {c}_{y} \\ 0 & 0 & 1\end{matrix} ) ( R / t ) ( X ) . \qquad [ Formula 1 ]$$

The region determination unit 330 determines a region to be included in the image generated by cropping from an image (hereinafter, referred to as “super-resolution image”) produced by applying super-resolution technique to the captured image acquired by the image acquisition unit 310. In the present exemplary embodiment, a circumscribed rectangle enclosing the subject 3 in a captured image acquired by the image acquisition unit 310 is determined to be a region (a region enclosing the subject) and supplied to the transformation unit 340. The super-resolution image is an example of the second image. The region determination unit 330 is an example of the detection unit.

The transformation unit 340 acquires outputs from the image acquisition unit 310, the geometric information acquisition unit 320, and the region determination unit 330, performs processing on the acquired image using super-resolution technique, and generates geometric information about the virtual camera corresponding to the super-resolution image. The generated super-resolution image and the generated geometric information about the virtual camera are output to the editing unit 350. When an image size of the image corresponding to a region enclosing the subject in the super-resolution image exceeds an image size of the acquired captured image, the region enclosing the subject in the super-resolution image is divided into a plurality of regions, and geometric information about the virtual camera for each of the plurality of divided regions is generated. The processing using super-resolution technique and processing of generating geometric information about the virtual camera can be performed by different apparatuses.

The editing unit 350 outputs the super-resolution image and the geometric information about the virtual camera acquired from the transformation unit 340 to the database 30 to edit the database 30. The super-resolution image can be registered after the captured image acquired by the image acquisition unit 310 and the information indicating the position and the orientation of the imaging apparatus 10 corresponding to the captured image are deleted, or the virtual camera can be added as a new imaging apparatus without the deletion.

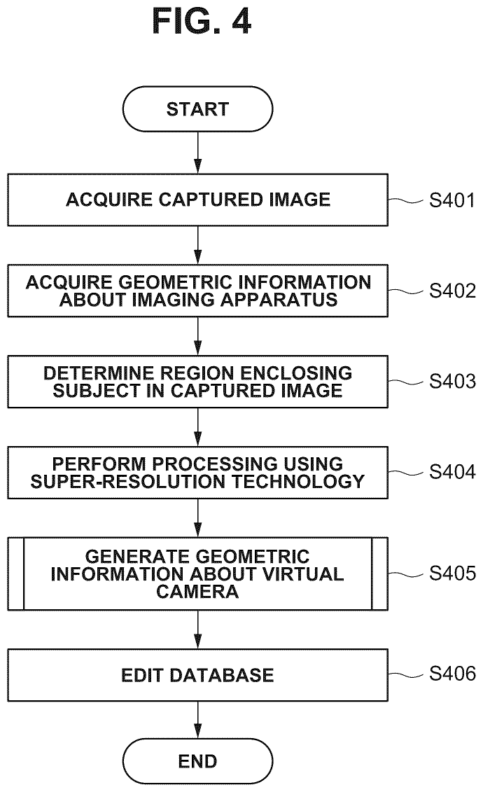

FIG. 4 is a flowchart illustrating image processing performed by the image processing apparatus 100 according to the present exemplary embodiment. The processing illustrated in FIG. 4 is performed to edit the database 30. The processing illustrated in FIG. 4 is performed by the CPU 201 executing control programs stored in the ROM 202 and loaded into the RAM 203.

In step S401, the image acquisition unit 310 acquires the image captured by the imaging apparatus 10 from the database 30. In the present exemplary embodiment, a captured image selected by the user from a plurality of images captured by the plurality of imaging apparatuses 10 is acquired.

In step S402, the geometric information acquisition unit 320 acquires geometric information about the imaging apparatus 10 by which the image acquired from the database 30 in step S401 has been captured, such as the position and the orientation of the imaging apparatus 10 and the focal length and the image center in pixel units.

In step S403, the region determination unit 330 detects a region including the subject 3 in the captured image acquired in step S401 and determines a circumscribed rectangle enclosing the detected region as a region enclosing the subject 3. The region detection can be performed using a background subtraction method or an object recognition method with machine learning.

In step S404, the transformation unit 340 performs processing on the captured image acquired in step S401 using super-resolution technique. In the present exemplary embodiment, processing using super-resolution technique based on machine learning with a single image is performed. In the processing using super-resolution technique based on machine learning, a pre-trained model is used to increase the number of pixels with respect to an input image, generating an output image with a resolution that is N times higher than that of the input image. In the present exemplary embodiment, the input image is the captured image acquired in step S401, and the output image is a super-resolution image with a resolution N times higher than that of the captured image.

In step S405, the transformation unit 340 generates geometric information about the virtual camera corresponding to a region including at least a portion of the subject 3 in the super-resolution image generated in step S404. The region including at least a portion of the subject 3 in the super-resolution image includes at least a portion of the region generated by enlarging the region enclosing the subject 3 in the captured image determined in step S403 through the processing using super-resolution technique. The region generated by enlarging the region enclosing the subject 3 in the captured image through the processing using super-resolution technique is an example of the first region. Further, the region including at least a portion of the subject 3 in the super-resolution image is an example of the second region. In the present exemplary embodiment, the resolution of the cropped image, which includes at least a portion of the subject 3 in the super-resolution image, is adjusted to match the resolution of the captured image acquired in step S401 and then registered. Details of a processing procedure performed to match the resolution of the image generated by cropping the region including at least a portion of the subject 3 in the super-resolution image to the resolution of the captured image acquired in step S401 will be described below.

In step S406, the database 30 is edited based on the super-resolution image generated in step S404 and the geometric information about the virtual camera generated in step S405. Here, a virtual camera 600 generated in step S405 is regarded as a new imaging apparatus, and the super-resolution image and geometric information about the virtual camera 600 are registered in the database 30. Information about the number of imaging apparatuses 10 included in the virtual viewpoint image generation system 1 is also edited. As a result of performing the processing using super-resolution technique, if the information about the imaging apparatus 10 corresponding to the captured image acquired in step S401 is unnecessary, the virtual camera 600 can be registered to replace the data about the imaging apparatus 10 corresponding to the captured image acquired in step S401.

While a captured image selected by the user from a plurality of images captured by the plurality of imaging apparatuses 10 is acquired in the present exemplary embodiment, this is not a limitation. In the case of the plurality of imaging apparatuses 10 corresponding to a plurality of captured images, the captured images can be acquired in the order of numbers assigned to the imaging apparatuses 10, starting from the smallest. Specifically, the process illustrated in FIG. 4 can be performed on all of the plurality of captured images.

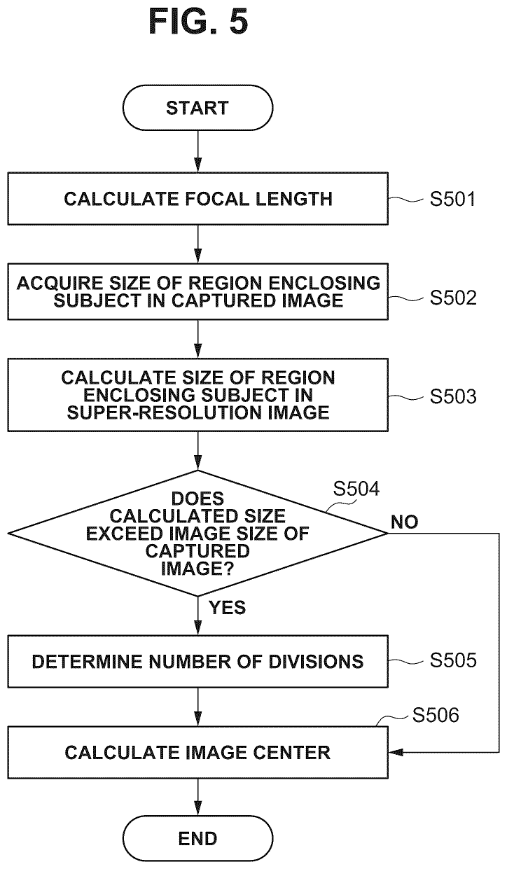

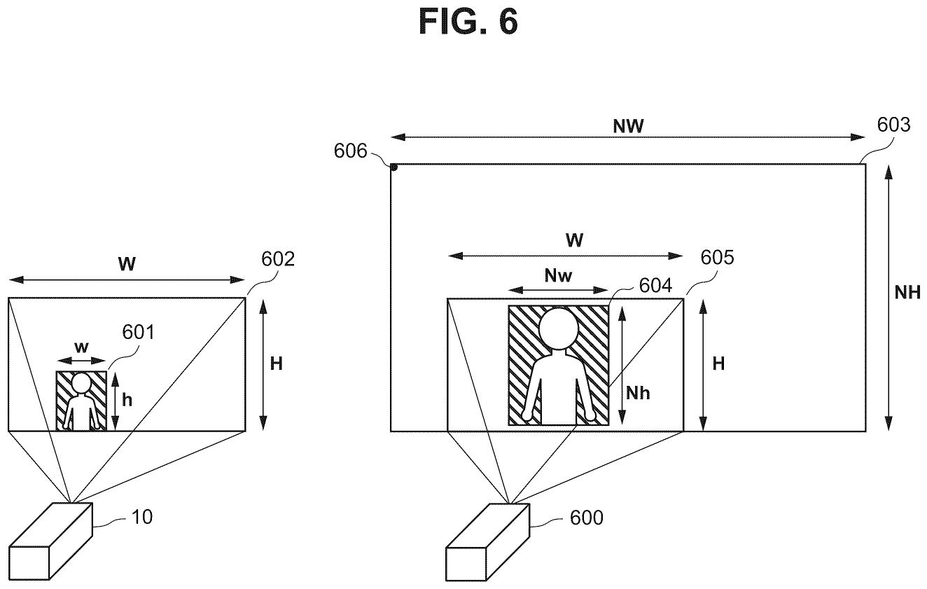

FIG. 5 is a flowchart illustrating a process of generating geometric information about the virtual camera by the image processing apparatus 100 according to the present exemplary embodiment. The flowchart in FIG. 5 illustrates a process of matching the resolution of the image generated by cropping the region including at least a portion of the subject 3 in the super-resolution image in step S405 to the resolution of the captured image acquired in step S401. FIG. 6 is a diagram illustrating an overview of the process.

In step S501, the focal length of a super-resolution image 603 is calculated. Since the focal length is represented in pixel units, the focal length is calculated based on the focal length of the imaging apparatus 10 corresponding to a captured image 602 acquired in step S401 and the rate of increase in the number of pixels in the processing using super-resolution technique. For example, when the image size is increased to N times its original size through the execution of the processing using super-resolution technique, the super-resolution image 603 with an image size that is N times larger than that of the captured image 602 acquired in step S401 is generated. The focal length of the imaging apparatus corresponding to the super-resolution image 603 with an image size increased to N times to its original size is N times larger than that of the imaging apparatus 10.

In step S502, the size (width w, height h) of a region 601 enclosing the subject in the captured image 602 determined in step S403 is acquired.

In step S503, the size (width Nw, height Nh) of the region 601 enclosing the subject in the captured image 602 acquired in step S502, the size (width Nw, height Nh) of which is increased to N times its original size, is calculated. The calculated size corresponds to the size of a region 604 enclosing the subject in the super-resolution image 603. The region 604 is an example of the first region.

In step S504, it is determined whether the size calculated in step S503 exceeds the image size (width W, height H) of the captured image 602 acquired in step S401, i.e., the image size of the captured image 602 captured by the imaging apparatus 10. If the calculated size exceeds the image size of the captured image (YES in step S504), the processing proceeds to step S505 to determine the number of divisions into which the region 604 enclosing the subject in the super-resolution image 603 is to be divided. If the calculated size does not exceed the image size of the captured image (NO in step S504), the processing proceeds to step S506.

In step S505, the number of divisions into which the region 604 enclosing the subject in the super-resolution image 603 is to be divided is determined. The number of horizontal divisions can be determined to be an integer of U=Nw/W or more, and the number of vertical divisions can be determined to be an integer of V=Nh/H or more.

In step S506, the image center of a region 605 including the region 604 enclosing the subject in the super-resolution image 603 is determined. The size of the region 605 is the same as the image size of the captured image 602 acquired in step S401. The image center herein refers to coordinates of the center of the image with the origin located at the upper left corner of the image, and is stored as coordinate values. The image center of the region 604 is calculated with the origin located at the upper left corner (a point 606 in FIG. 6) of the super-resolution image 603. When the region 604 is divided in step S505, the processing calculates an image center for each of the plurality of regions 605 including the divided regions. The region 605 is an example of the second region.

Since the focal length of the virtual camera corresponding to a region including the region enclosing the subject in the super-resolution image and the image center are calculated by the above-described process, geometric information about the virtual camera can be generated. Further, a cropped image of the region including the region enclosing the subject in the super-resolution image can also be generated from the super-resolution image. Thus, the cropped image and the geometric information about the virtual camera can be used in processes of coloring a virtual viewpoint image and of generating three-dimensional shape information about the subject.

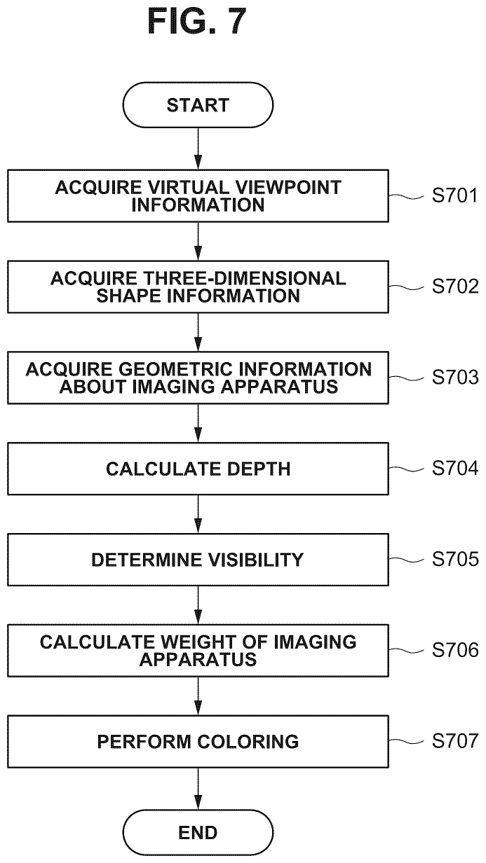

FIG. 7 is a flowchart illustrating a process of generating a virtual viewpoint image by the rendering apparatus 40 according to the present exemplary embodiment. The rendering apparatus 40 performs the process regardless of whether the database 30 is edited by the image processing apparatus 100.

In step S701, the rendering apparatus 40 acquires information indicating the position and the orientation of the virtual camera (virtual viewpoint information) input from the input apparatus 50. The virtual camera here is different from the virtual camera generated by the image processing apparatus 100 in step S405.

In step S702, the rendering apparatus 40 acquires three-dimensional shape information about the subject 3 from the database 30.

In step S703, the rendering apparatus 40 acquires geometric information about the imaging apparatus 10 from the database 30. Here, when the database 30 is edited by the image processing apparatus 100 according to the present exemplary embodiment, geometric information about the virtual camera 600 generated by performing the processing using super-resolution technique is similarly acquired.

In step S704, the rendering apparatus 40 calculates the depth to the shape surface of the subject 3 as viewed from the virtual camera corresponding to the information about the position and the orientation about the virtual camera acquired in step S701.

In step S705, what portion of the shape surface of the subject 3 is visible from each of the plurality of imaging apparatuses 10 is determined based on the geometric information about the imaging apparatus 10 acquired in step S703. The foregoing processing identifies visible and invisible portions of the three-dimensional shape of the subject 3 for each imaging apparatus 10.

In step S706, the weight used for coloring is calculated for each portion of the three-dimensional shape of the subject 3 using the imaging apparatus(es) 10 from which the portions are determined to be visible in step S705. The weight is determined based on the difference in angle between the optical axes of the virtual camera and the imaging apparatus 10. Here, the image cropped from the super-resolution image registered in the database 30 in step S406 and the geometric information about the virtual camera generated in step S405 can be used preferentially in coloring. In this case, the calculation is performed to assign a higher weight to the virtual camera generated in step S405.

In step S707, the three-dimensional shape of the subject 3 in the virtual viewpoint image is colored based on the weights calculated in step S706. A color can be determined using a weighted average based on the weights, or the color from the imaging apparatus 10 assigned the highest weight can be used.

As described above, the rendering apparatus 40 can generate a virtual viewpoint image through the same process regardless of whether the captured images and geometric information about the imaging apparatuses 10 stored in the database 30 are edited. Thus, even when the database 30 is edited by the image processing apparatus 100, a virtual viewpoint image can be generated using an image cropped from the super-resolution image and geometric information about the corresponding virtual camera stored in the database 30.

In the present disclosure, processing load can be reduced during high-definition virtual viewpoint image generation.

In the present exemplary embodiment, while the processing using super-resolution technique as processing for improving image quality is described, an image quality enhancement process, such as a denoising process, can also be performed, and the result can be registered as that of a new imaging apparatus. The weights for the processing using super-resolution technique based on machine learning can be weights pre-trained using a general-purpose dataset or weights trained specially for a target scene.

While in the present exemplary embodiment, the example has been described in which the processing using super-resolution technique with a single image, processing using super-resolution technique with a plurality of viewpoint images or a multi-frame image can be performed.

While in the present exemplary embodiment, an example has been described in which information is stored as a focal length in pixel units, a focal length in millimeters and the number of pixels per millimeter can be stored as the corresponding information. In this case, the number of pixels per millimeter is calculated to be 1/N times the original value through processing using N-fold super-resolution technique.

In the present exemplary embodiment, since the region enclosing the subject in the captured image is determined, geometric information about the virtual camera corresponding to the region including the region enclosing the subject 3 in the super-resolution image varies with each frame. This is acceptable to a system where varying geometric information for each frame does not pose an issue. However, geometric information about the imaging apparatus 10 remains constant throughout the scene. To accommodate such a system, geometric information about the virtual camera corresponding to the region including the region enclosing the subject 3 in the super-resolution image is configured to remain constant, instead of variation with each frame.

Computer programs for performing some or all of the controls according to the present exemplary embodiment and the functions of the above-described embodiment can be supplied to an imaging processing system via a network or various storage media. Then, a computer (or CPU or micro-processing unit (MPU)) of the imaging processing system can read the programs and execute the read programs. In this case, the programs and the storage medium storing the programs are included in the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-053579, filed Mar. 28, 2024, which is hereby incorporated by reference herein in its entirety.

What is claimed is:

1. An imaging processing apparatus comprising:
one or more memories storing instructions; and
one or more processors that, upon execution of the instructions, configures the one or more processors to:
acquire a first image captured by an imaging apparatus;
generate a second image by increasing a number of pixels of the first image; and
set information indicating a position and an orientation of a virtual camera corresponding to the second image.

2. The imaging processing apparatus according to claim 1, wherein the information indicating the position and the orientation of the virtual camera corresponds to a first region including at least a portion of a subject included in the second image.

3. The imaging processing apparatus according to claim 2, wherein the first region encloses the subject included in the second image.

4. The imaging processing apparatus according to claim 1, wherein the first region is a same size as the first image.

5. The imaging processing apparatus according to claim 2, wherein the first region includes at least a portion of a second region in the second image that was generated by enlarging a third region that encloses the subject included in the first image by increasing the number of pixels.

6. The imaging processing apparatus according to claim 5, wherein the first region is a region that includes the second region.

7. The imaging processing apparatus according to claim 1, wherein execution of the stored instructions further configures the one or more processors to output the second image and the information indicating the position and the orientation of the virtual camera to an external apparatus.

8. The imaging processing apparatus according to claim 1, wherein the second image is generated by increasing the number of pixels is processing using super-resolution technique.

9. The imaging processing apparatus according to claim 1, wherein execution of the stored instructions further configures the one or more processors to acquire information indicating a position and an orientation of the imaging apparatus, and
wherein the information indicating the position and the orientation of the virtual camera is set based on the information indicating the position and the orientation of the imaging apparatus and information about increasing the number of pixels.

10. The imaging processing apparatus according to claim 1, wherein execution of the stored instructions further configures the one or more processors to acquire the first image from a plurality of captured images of a subject, the plurality of captured images captured from a plurality of directions.

11. The imaging processing apparatus according to claim 9, wherein the information indicating the position and the orientation of the imaging apparatus includes information indicating a focal length of the imaging apparatus, and the information indicating the position and orientation of the virtual camera includes information indicating a focal length of the virtual camera.

12. An imaging processing system comprising:
one or more memories storing instructions; and
one or more processors executing the instructions to:
acquire a first image captured by an imaging apparatus;
generate a second image by increasing a number of pixels of the first image;
set first viewpoint information indicating a position and an orientation of a virtual camera corresponding to the second image;
acquire second viewpoint information indicating a position and an orientation of another virtual camera different from the virtual camera; and
generate a virtual viewpoint image based on the second image, the first viewpoint information, and the second viewpoint information.

13. An information processing method comprising:
acquiring a first image captured by an imaging apparatus;
generating a second image by increasing a number of pixels of the first image; and
setting information indicating a position and an orientation of a virtual camera corresponding to the second image.

14. A non-transitory computer readable storage medium storing a program that, when executed by a processing apparatus, causes the processing apparatus to perform an image processing method, the method comprising:
acquiring a first image captured by an imaging apparatus;
generating a second image by increasing a number of pixels of the first image;
setting first viewpoint information indicating a position and an orientation of a virtual camera corresponding to the second image;
acquiring second viewpoint information indicating a position and an orientation of another virtual camera different from the virtual camera; and
generating a virtual viewpoint image based on the second image, the first viewpoint information, and the second viewpoint information.
